(19) United States
(12) Patent Application Publication
(10) Pub. No.: US 2020/0147517 A1
(43) Pub. Date: May 14, 2020

(54) ESSENTIAL OIL EXTRACTION SYSTEMS

(71) Applicant: Lew Swan, Gresham, OR (US)

(72) Inventor: Lew Swan, Gresham, OR (US)

(21) Appl. No.: 16/190,890

(22) Filed: Nov. 14, 2018

(51) Int. Cl. B01D 11/02; C11B 1/10; C11B 9/02

(52) U.S. Cl. CPC B01D 11/0296; B01D 11/0219; B01D 2011/007; C11B 9/025; C11B 1/10

(57) ABSTRACT

A method, device, system, or apparatus for extracting an essential oil from a material. The device may include a material chamber, a heater, and a coil. The material chamber may include a cavity to store a material and a gas. The heater may be approximate to the material chamber and may apply heat to the material chamber to heat the material to a first threshold temperature. The material may release an essential oil in a gas state at the first threshold temperature that combines with the gas to form a gaseous mixture. The coil may be connected to the material chamber and may receive the gaseous mixture from the material chamber. The coil may cool the gaseous mixture to a second threshold temperature and the essential oil may change from the gas state to a liquid state at the second threshold temperature.

### BACKGROUND

Essential oils may denote a group of native substances which are obtainable from organic or inorganic material. For example, essential oils may include hydrocarbons, such as terpenes and the oxygenated compounds. Many essential oils that have applications in the food industry, the tobacco industry, the perfume industry, and the pharmaceutical industry. For example, essential oils are widely used as ingredients for fragrances, flavoring mixtures, and medicinal remedies. To put the essential oils in a usable form, the essential oils are extracted from the organic or inorganic materials.

### SUMMARY

A method, device, system, or apparatus for extracting an essential oil from a material. The device may include a material chamber, a heater, and a coil. The material chamber may include a cavity to store a material and a gas. The heater may be approximate to the material chamber and may apply heat to the material chamber to heat the material to a first threshold temperature. The material may release an essential oil in a gas state at the first threshold temperature that combines with the gas to form a gaseous mixture. The coil may be connected to the material chamber and may receive the gaseous mixture from the material chamber. The coil may cool the gaseous mixture to a second threshold temperature. The essential oil may change from the gas state to a liquid state at the second threshold temperature.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates an essential oil extraction system to extract essential oils from a material, according to an embodiment.

FIG. 2 illustrates a flowchart for a method to extract an essential oil from a material, according to an embodiment.

### DETAILED DESCRIPTION

The disclosed essential oil extraction systems will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various essential oil extraction systems are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Essential oils are native substances obtainable from organic materials and/or inorganic materials and are widely used as ingredients for fragrances, flavoring mixtures, and medicinal remedies. The essential oils may include hydrocarbons, such as terpenes and the oxygenated compounds. To put the essential oils in a usable form, the essential oils are extracted from the organic material or the inorganic material.

The essential oils are obtained by extracting the oils from the organic materials and/or inorganic materials using extraction processes. Conventional extraction processes may include steam distillation, solvent extraction, or mechanical separation or pressing of the essential oils from the plant material. For steam distillation, the essential oils may be separated or distilled by decantation of the essential oil from a steam distillate. For solvent extraction or mechanical separation or pressing, the essential oils may be filtered from a solvent or remnant materials using a filter.

The conventional afore-mentioned processes, however, may be inefficient, expensive, and degrade the organic and/or inorganic materials during the extraction process. In the case of steam distillation, the essential oils are usually contained only in minor quantities in the plant materials. The ratio of steam or water to essential oil in the steam distillate is relatively large. The large amount of steam or water used for steam distillation of the essential oils causes problems in the subsequent phase of separating the essential oils from the steam or water. The difficulty in separating the essential oils from the water may cause a significant amount of essential oil to remain dissolved in the aqueous phase after the separation. Furthermore, the steam distillation process uses a relatively large volume of steam to extract the essential oils. The generation of the steam may be relatively expensive compared to the amount of essential oils extracted during the process.

In the case of solvent extraction or mechanical separation or pressing, these extraction processes may degrade or damage the organic material and/or inorganic material that the essential oils are extracted from. For example, when solvents are applied to the organic material and/or the inorganic material, the solvents may cause the organic material and/or inorganic material to deteriorate as the solvent breaks down the organic material and/or inorganic material to release the essential oils. Additionally, the solvent (such as ethanol gas) may chemically bond with the essential oils such that the solvent may not be seperated from the essential oils.

Similarly, the mechanical separation or pressing flattens and crushes the organic material and/or the inorganic material as the essential oils are extracted. As the organic material and/or the inorganic material is degraded or destroyed, the organic material and/or the inorganic material may not be reusable for other purposes, such as for decoration, consumption, ingredients in other products, and so forth. Additionally, the solvent(s) and/or remnant material from the solvent extraction or mechanical separation or pressing may be difficult, expensive, and time-consuming to separate from the essential oils.

Implementations of the disclosure address the above-mentioned deficiencies and other deficiencies by providing methods, systems, devices, and/or apparatuses to extract essential oils from organic materials and/or inorganic materials. The essential oil extraction system may include a gas cylinder, a material chamber, a heater, a condensing coil, and a collection chamber. In one example, the organic material and/or the inorganic material may be placed in the material chamber. Gas from the gas cylinder may be then be pumped into the material chamber. The material chamber may then be heated by the heater to heat the gas and the organic material and/or the inorganic material. As the gas and the organic material and/or the inorganic material are heated, the essential oils from the organic material and/or the inorganic material may be released into the gas. A gas mixture that includes the essentials oils and the gas may then be directed through the coil where the gaseous mixture may be cooled to a temperature that the essential oils may change back to a liquid state while the gas stays in a gas state. The liquid essential oils may then be collected in the collection chamber and be ready to use by an individual for a variety of purposes.

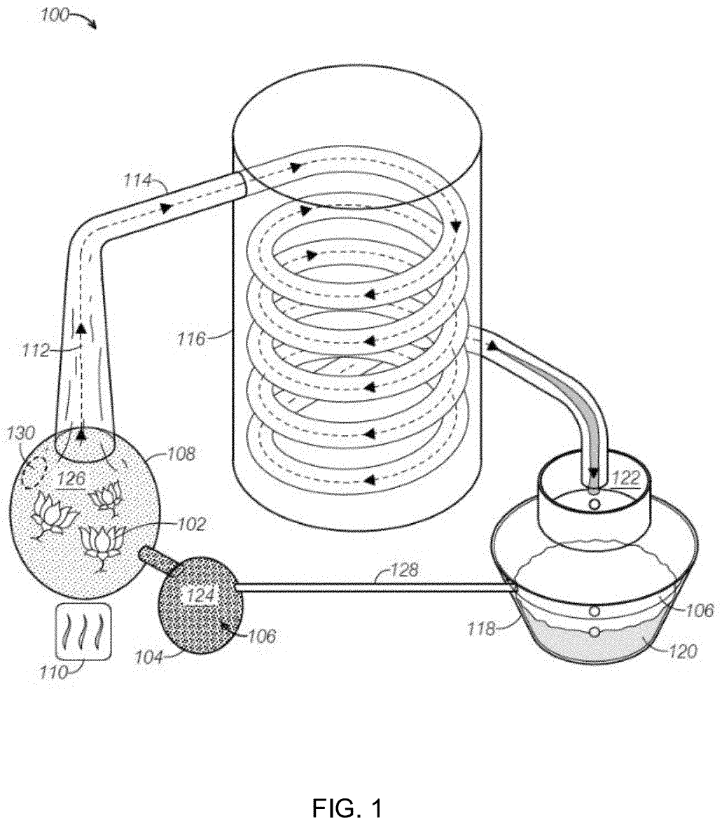

FIG. 1 illustrates an essential oil extraction system 100 to extract essential oils from a material 102, according to an embodiment. The essential oil extraction system 100 may include a gas cylinder 104 with a cavity 124 to store a gas 106. In one example, the gas 106 may be a light gas, such as nitrogen, hydrogen, helium, and so forth. In another example, the gas 106 may be an inert gas that may not undergo chemical reactions when heated, such as bonding with essential oils in a gas stage. In one embodiment, the inert gas may be nitrogen, helium, argon, neon, krypton, xenon, radon, and so forth. In another example, the gas 106 may be air from the environment surrounding the material chamber 108 or may be filtered air.

The gas cylinder 104 may be connected to the material chamber 108. The material chamber 108 may include a cavity 126 to store the material 102. In one example, the gas cylinder 104 and/or the material chamber 108 may be a metal material, a plastic material, a glass material, and so forth. In another example, the gas cylinder 104 and/or the material chamber 108 may be a material that does not leach material onto the material 102 or into the gas 106.

In one example, the material 102 may be organic material. The organic material may be a plant, such as a fruit, a flower, cannabis, a berry, bark, a leaf, resin, a rhizome, a root, a seed, a peel, wood, and so forth. In another example, the material 102 may be an inorganic material. The inorganic material may be materials created or manufactured using chemistry, organic materials that include inorganic materials (such as fertilizers or micro-organisms), and so forth. A user may place the material 102 into the cavity 126 of the material chamber 108.

When the material 102 has been placed in the cavity 126, the material chamber 108 may be sealed. In one example, the cavity 126 may be sealed with an O-ring that runs along an opening 130 of the material chamber 108 that may be opened to receive the material 102 and closed after the material 102 is in the cavity 126. When the cavity 126 is sealed, the air in the material chamber 108 may be removed from the cavity 126. In one example, the material chamber 108 may be a vacuum chamber void of air and the gas is an inert gas that does not introduce oxygen or moisture into the material chamber 108. In one embodiment, the air may be removed by a vacuum. In another embodiment, the air may be removed using positive pressure to force the air out as the gas 106 in the cavity 124 is pumped into the cavity 126.

When the cavity 126 is filled with the gas 106, the heater 110 may be turned on to heat the gas 106 and the material 102 in the cavity 126. In one embodiment, the heater 110 may be a separate device that is located approximate to the material chamber 108. For example, the heater 110 may be in contact with the material chamber 108 or next to the material chamber 108 so that the material chamber 108 receives the heat generated by the heater 110. In another example, the heater 110 may be integrated into the material chamber 108 so that the heat generated by the heater is directed into the cavity 126.

The gas 106 may be an inert gas that does not damage or degrade the material 102. In one embodiment, when the gas 106 is nitrogen and the air has been removed from the cavity 126, the nitrogen may surround the material 102 without damaging the material 102 with moisture, non-inert compounds, or active compounds. For example, the inert gas may not break down the cells of the material 102, such as plant cells, as the inert gas is used to extract the essential oil from the material 102.

As the material 102 is heated to a threshold temperature, essential oils of the material 102 may switch from a liquid state to a gas state. The essential oils may be hydrocarbons, such as terpenes and/or oxygenated compounds. For example, the essential oils may be cannabinoids, tetrahydrocannabinol (THC), cannabidiol (CBD), plant oil extract, or other natural oils. In one embodiment, the essential oils may be non-fatty oils that include multiple compounds. In one example, the compounds may include volatile substances and/or lipophilic substances. In another example, the compounds may include hydrocarbons or mono-functional compounds derived from the metabolism of mono-terpenes, sesqui-terpenes, phenylpropanoic acids, fatty acids, and so forth. In another example, the essential oils may be oils extracted from mint plants, rosemary plants, lavender plants, lavender plants, lime plants, juniper plants, cannabis plants, coriander plants, and so forth.

The threshold temperature may be a boiling point of the essential oils within the material 102 so that the essential oils will change from a liquid state to a gas state. For example, the threshold temperature may be a temperature to convert the essential oils to a gas state while not degrading the material 102. In one example, the threshold temperature may vary based on the type of material 102. For example, when the essential oil of the material 102 may change to a gas state at 90 degrees (°) Fahrenheit (F), the threshold temperature may be 90° F. In another example, when the essential oils of the materials 102 may change to the gas state at 120° F. then the threshold hold temperature may be 120° F.

In one example, the heater 110 may include a temperature controller to control an amount of heat that is applied to the material chamber 108 to heat the material 102. For example, depending on the type of material 102, the essential oils in the material 102 may have different boiling points where the essential oils switch from the liquid state to the gas state. The temperature controller may adjust the temperature produced by the heater 110 to heat the material, via the material chamber 108, to at least the boiling point of the essential oil. In another example, as the gas 106 and/or the material 102 is heated within the material chamber 108, the gas 106 and/or the gaseous essential oil may increase an amount of pressure within the material chamber 108. The material chamber 108 and/or the coil 114 may include a pressure relief valve to release at least a portion of the pressure from the material chamber 108 and/or the coil 114 when the amount of pressure exceeds a threshold amount of pressure.

The threshold temperature may be a temperature range, where the minimum temperature is the minimum temperature for the essential oils to change to a gas state and the maximum temperature is the maximum temperature before the material 102 may degrade or be destroyed. As the essential oils switch to the gas state, the gaseous essential oils may intermix with the gas 106 to form a gaseous mixture 112.

While the gaseous mixture 112 is created, the material 102 may remain substantially intact and undamaged except that the material 102 has a reduced amount of essential oils contained in the material 102. The removal of the essential oils from the material without damaging or degrading the material 102 may be beneficial, as the material 102 may be used for other purposes. For example, when the material 102 is a plant, such as a delicate flowering plant, the extraction process described herein may not damage or degrade the plant. After the essential oil has been removed from the plant, the plant may be used for decoration, consumption, ingredients in other products, medicinal purposes, and so forth. Additionally, the gas 106 may be an inert gas that does not change the composition of the liquid or gaseous essential oil.

As discussed below, the gas 106 may be separated from the essential oil. When the gas 106 is inert, the gas 106 may be separated from the essential oil without changing a composition of the essential oil or degrading a purity of the essential oil. For example, while the gas 106 and the gaseous essential oils may intermix, compounds from the gas 106 may not leach onto the gaseous essential oils so that when the gas 106 and the gaseous essential oils are separated, the essential oils remain pure. The material chamber 108 may include a drip chamber or a drip spout so that water or other liquids that may sweat from the material 102 may be released or removed from the material chamber 108. For example, if the material 102 sweats or releases water during the extraction process, the drip chamber or drip spout may be used to remove the water from the material chamber 108.

The gaseous mixture 112 may be channeled to a coil 114. In one example, the essential oil extraction system 100 may include a pump that pumps the gaseous mixture 112 from the cavity 126 to the coil 114. In another example, as the gas 106 is pumped into the cavity 126, positive pressure may force the gaseous mixture 112 into the coil 114. In one example, the gas cylinder 102 may be connected to a bottom or side of the material chamber 108. In another example, the coil 114 may be connected to a top of the material chamber 108. In one embodiment, as the gas is pumped into the cavity 126 of the material chamber 108, the pressure from the pumping may force the gaseous mixture 112 into the coil 114. In another example, the gas 106 may be a light gas and when combined with the gaseous essential oils, the light gas may lift the gaseous mixture 112 into the coil 114. In another example, as heat is applied to the gas 106, the gas 106 may naturally rise to a top of the cavity 126. When the gas 106 is intermixed with the gaseous essential oils to form the gaseous mixture 112, the gaseous mixture 112 may rise to the top of the cavity 126 when heat is applied to the gaseous mixture 112.

The coil 114 may be condenser coil that releases heat from the gaseous mixture 112. In one example, the coil 114 may be surrounded by air in the surrounding environment and may release the heat from the gaseous mixture 112 into the air. In another example, the coil may at least partially be surrounded by a cooling device 116. The cooling device may at least partially aid the coil 114 in cooling the gaseous mixture to a threshold temperature. In one example, the cooling device 116 may be a refrigeration system to cool the coil 114 and the surrounding air to a defined temperature. In another example, the cooling device 116 may be a liquid, such as cold water, that may cool at least a portion of the coil 114 to the defined temperature. In another example, the coil 114 may be a vacuum jacketed coil. In one embodiment, the threshold heating temperature is greater than the threshold cooling temperature.

The defined temperature may be a temperature where the gaseous essential oil changes from the gas state to the liquid state and the gas 106 continues to be in the gas state. As the gaseous essential oil changes to the liquid state and the gas 106 continues to be in the gas state, the essential oils may separate from the gas 106. The coil 114 may be connected to a collection chamber 118. In one example, the collection chamber 118 may be a metal material, a plastic material, a glass material, and so forth. In another example, the collection chamber 118 may be a material that does not leach material onto the material 102 or into the gas 106.

As the gaseous mixture 112 is channeled through the coil 114 and separates into the essential oil and the gas 106, the gas 106 and the essential oil may be channeled to the collection chamber 118. The collection chamber 118 may include a cavity 122 configured to receive the gas 106 and the liquid essential oil 120. When the boiling point of the essential oil that forms the gaseous mixture 112 with the gas 106 has a relatively low boiling point, the extracting of the essential oil from the material 102 may take a relatively low amount of time as compared to the boiling of water for steam because the essential oil changes to gas at a lower temperature than the water.

The liquid essential oil 120 in the cavity 122 may then be removed by an individual and used for a variety of purposes, such as in the food industry, the tobacco industry, the perfume industry, the industry pharmaceutical, and so forth. For example, the collection chamber 118 may have a lid or spout for the individual to remove the essential oil 120 from the collection chamber 118.

In one example, the gas 106 may be released into the surrounding environment. In another example, the gas 106 may be directed into a recirculation line 128. The recirculation line 128 may direct the gas 106 back into the cavity 124 of the gas cylinder 104 or the cavity 126 of the material chamber 108 to be reused in the essential oil extraction process.

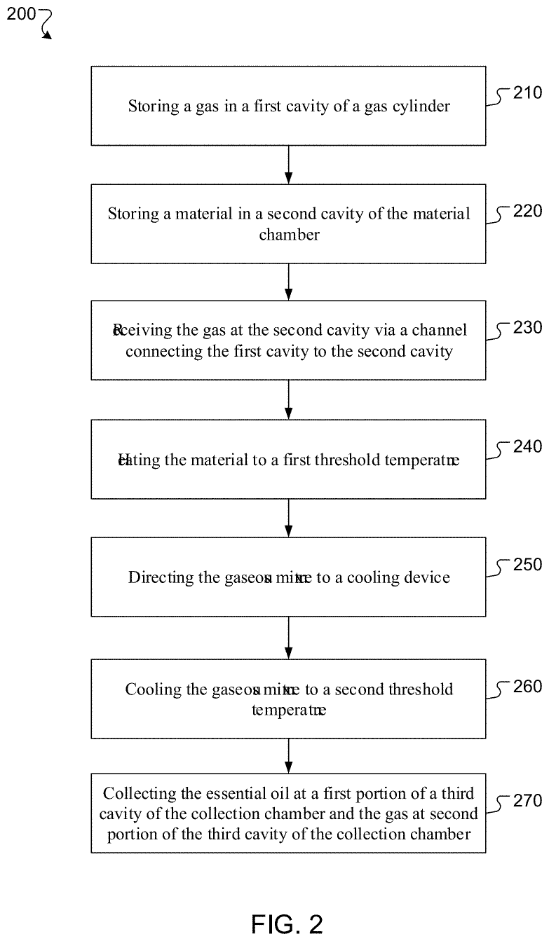

FIG. 2 illustrates a flowchart 200 for a method to extract an essential oil from a material, according to an embodiment. The method may begin with storing a gas in a first cavity of a gas cylinder (block 210). The method may include storing a material in a second cavity of the material chamber (block 220). The method may include receiving, from the first cavity, the gas at the second cavity via a channel connecting the first cavity to the second cavity (block 230). The method may include heating, by a heater, the material to a first threshold temperature (block 240). In one example, when the material may be heated to the first threshold temperature, the material may release an essential oil in a gas state and the essential oil and the gas may combine to form a gaseous mixture. The method may include directing the gaseous mixture to a cooling device (block 250). The method may include cooling, by the cooling device, the gaseous mixture to a second threshold temperature (block 260). In one example, the essential oil may change from the gas state to a liquid state at the second threshold temperature while the gas maintains a gas state. The method may include collecting, by the collection chamber connected to the coil, the essential oil at a first portion of a third cavity of the collection chamber and the gas at a second portion of the third cavity of the collection chamber (block 270).

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A system, comprising:
a gas cylinder comprising a first cavity to store a gas;
a material chamber connected to the gas cylinder, the material chamber comprising:
a second cavity;
a first opening configured to receive the gas from the first cavity at the second cavity; and
a second opening to receive a material in the second cavity;
a heater approximate to the material chamber, wherein:
the heater is operable to apply heat to the material chamber to heat the material to a first threshold temperature;
the material is to release an essential oil in a gas state at the first threshold temperature; and
the essential oil and the gas combine to form a gaseous mixture;
a coil connected to the material chamber, wherein:
the gaseous mixture is directed into the coil;
the coil is operable to cool the gaseous mixture to a second threshold temperature; and
the essential oil is to change from the gas state to a liquid state at the second threshold temperature while the gas maintains a gas state; and
a collection chamber connected to the coil, wherein the collection chamber comprises a third cavity with a first portion to store the essential oil and a second portion to store the gas.

2. The system of claim 1, further comprising a pump to direct the gaseous mixture into the coil.

3. The system of claim 1, wherein:
the coil is connected to a top of the material chamber; and
the gaseous mixture rises toward a top portion of the material chamber.

4. The system of claim 1, further comprising a recirculation line connecting the second portion of the collection chamber to the gas cylinder to direct the gas from the second portion of the collection chamber and the gas cylinder.

5. The system of claim 1, wherein the essential oil is a substance native to the material.

6. The system of claim 1, wherein the essential oil is at least one of a terpene, a cannabinoid, a hydrocarbon, or an oxygenated compound.

7. The system of claim 1, wherein the material is an organic material.

8. The system of claim 1, further comprising a cooling device approximate to the coil to at least partially aid in cooling the coil to the second threshold temperature.

9. The system of claim 1, wherein the first threshold temperature is great than the second threshold temperature.

10. The system of claim 1, wherein at least one of the first threshold temperature or the second threshold temperature varies based on a type of the material.

11. The system of claim 1, wherein the gas is an inert gas that does not undergo a chemical reaction to chemically bond to the essential oil when heated.

12. The system of claim 1, wherein the gas is a light gas.

13. A device, comprising:
a material chamber, comprising a first cavity configured to store a material and a gas;
a heater approximate to the material chamber, the heater being operable to apply heat to the material chamber to heat the material to a first threshold temperature, wherein the material is to release an essential oil in a gas state at the first threshold temperature that combines with the gas to form a gaseous mixture; and
a coil connected to the material chamber, the coil being operable to receive the gaseous mixture from the material chamber, wherein:
the coil is operable to cool the gaseous mixture to a second threshold temperature; and
the essential oil changes from the gas state to a liquid state at the second threshold temperature.

14. The device of claim 13, further comprising a collection chamber connected to the coil, wherein the collection chamber comprises a second cavity with a first portion to store the essential oil and a second portion to store the gas.

15. The device of claim 13, wherein the material chamber further comprises:
a first opening configured to receive the gas; and
a second opening for receiving the material into the first cavity.

16. The device of claim 15, wherein positive pressure from receiving the gas removes air from the material chamber.

17. The device of claim 13, further comprising a vacuum connected to the material chamber, wherein the vacuum is configured to remove air from the first cavity of the material chamber.

18. The device of claim 13, wherein the material chamber is a vacuum chamber void of air and the gas is an inert gas that does not introduce oxygen or moisture into the material chamber.

19. A method, comprising:
heating, by a heater, a material in a material chamber to a first threshold temperature, wherein:
the material is to release an essential oil in a gas state at the first threshold temperature, and
the essential oil and a gas combine to form a gaseous mixture at the first threshold temperature;
cooling, by a cooling device, the gaseous mixture to a second threshold temperature, wherein the essential oil is to change from the gas state to a liquid state at the second threshold temperature; and
collecting the essential oil from the cooling device.

20. The method of claim 19, further comprising recirculating the gas from the cooling device to the material chamber.
